(19) United States
(12) Patent Application Publication
(10) Pub. No.: US 2009/0121505 A1
(43) Pub. Date: May 14, 2009

(54) BATTERY- POWERED TELESCOPIC GRASPING APPARATUS

(76) Inventor: Michael Shatilla, Old Bridge, NJ (US)

Correspondence Address: MEREDITH & KEYHANI, PLLC, 330 MADISON AVE., 6TH FLOOR, NEW YORK, NY, 10017, US

(21) Appl. No.: 11/937,587

(22) Filed: Nov. 9, 2007

(51) Int. Cl. B25J 18/02; H02J 7/00

(52) U.S. Cl. 294/19.1; 320/114

(57) ABSTRACT

An apparatus for grasping items located at a distance from the operator, the apparatus comprising: a hook; a power means; an actuation means; a telescoping barrel in communication with the hook; a handle in communication with the telescoping barrel; an extending means contained within the telescoping barrel and in electrical communication with the actuation means and the power means, wherein the extending means extends the telescoping barrel and the actuation means optionally actuates the hook according to user input.

The present invention relates to apparatus for grasping items out of reach by a user.

It is often desirable to reach for items at an elevated location. Tasks such as changing a light bulb, cleaning a ceiling fan, reaching for items out of reach and numerous other tasks require a user to reach and in many instances grasp items.

Another problem is that arthritis and hand injuries impact many individuals and make it difficult to grasp items. Accordingly, it is desirable to have a push button operated apparatus that open and closes to avoid repetitive stress and fine motor movement by the hand of the user. For example, many reaching devices require the user to grasp to actuate the hook. By way of example, U.S. Pat. No. 6,739,637 issued to Hsu provides a gripping device which includes a hand grip rotatably secured to a handle, a tube secured to the handle, a tool member coupled to a pipe, a beam slidably received in the pipe and couple to a bar. The problem is that to extend the pipe requires the users to open the lever and adjust the tube, which requires hand movements. Also, to actuate the hook the user must squeeze the handle. These movements may be nearly impossible for persons with arthritis and hand injuries including carpel tunnel syndrome.

The present invention is also intended to solve the specific problem of reaching for clothing items at department stores. Waiting for a store associate to come and help a customer can result in lost sales to the store and aggravation on the part of the customer at having to wait to try on/look at clothing. Many of the hooks in the prior art are too rounded to accommodate clothing hooks. Accordingly, it is an object of the present invention to provide a hook which is particularly well suited for grasping clothing items at elevated locations and lowering the items without dropping the clothing on the floor.

Accordingly, the present invention provides an apparatus for grasping items at an elevated location and in particular a push button actuated device that is particularly suitable for retrieving clothing items.

These and other features, aspects and advantages of the present invention will become better understood with reference to the following description and claims.

### SUMMARY OF THE INVENTION

The present invention relates generally to apparatus for grasping items out of reach by a user.

According to one embodiment of the present invention, an apparatus for grasping items located at a distance from the operator is provided, the apparatus comprising: a hook; a power means; an actuation means; a telescoping barrel in communication with the hook; a handle in communication with the telescoping barrel; an extending means contained within the telescoping barrel and in electrical communication with the actuation means and the power means, wherein the extending means extends the telescoping barrel and the actuation means actuates the telescoping barrel according to user input.

According to another embodiment of the present invention, an apparatus for grasping items located at a distance from the operator, the apparatus comprising: a hook comprising two opposing sides, each of the two opposing sides being a first portion at an angle between 95 and 175 degrees from a second portion and a third portion at an angle of 95 to 140 degrees to the second portion; a center support peg interposed between the first portion and the second portion; a power means; an actuation means; a telescoping barrel in communication with the hook; a handle in communication with the telescoping barrel; an extending means contained within the telescoping barrel and in electrical communication with the actuation means and the power means, wherein the extending means extends the telescoping barrel and the actuation means actuates the telescoping barrel and optionally the grasping hook according to user input.

These and other features, aspects and advantages of the present invention will become better understood with reference to the following description and claims.

### BRIEF DESCRIPTION OF THE DRAWINGS

FIG. 1 depicts the present invention;

FIG. 2 depicts the present invention;

FIG. 3 depicts the present invention;

FIG. 4 depicts the present invention;

FIG. 5 depicts the present invention; and

FIG. 6 depicts the present invention.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

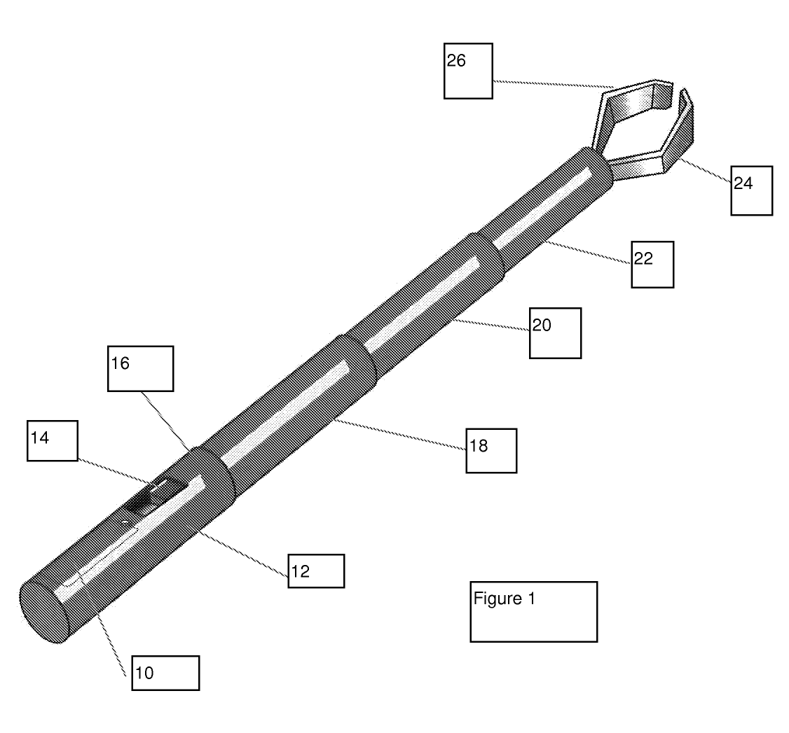

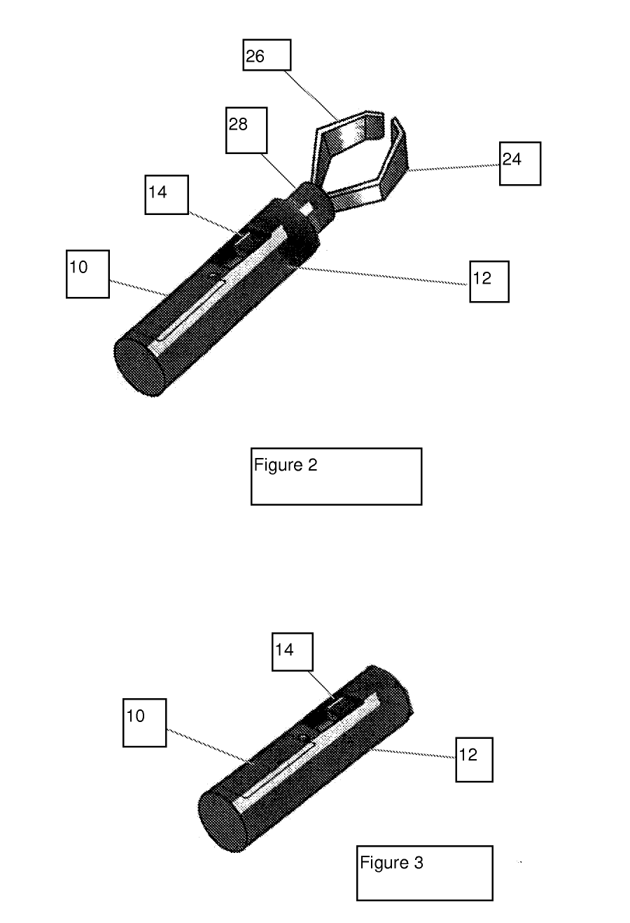

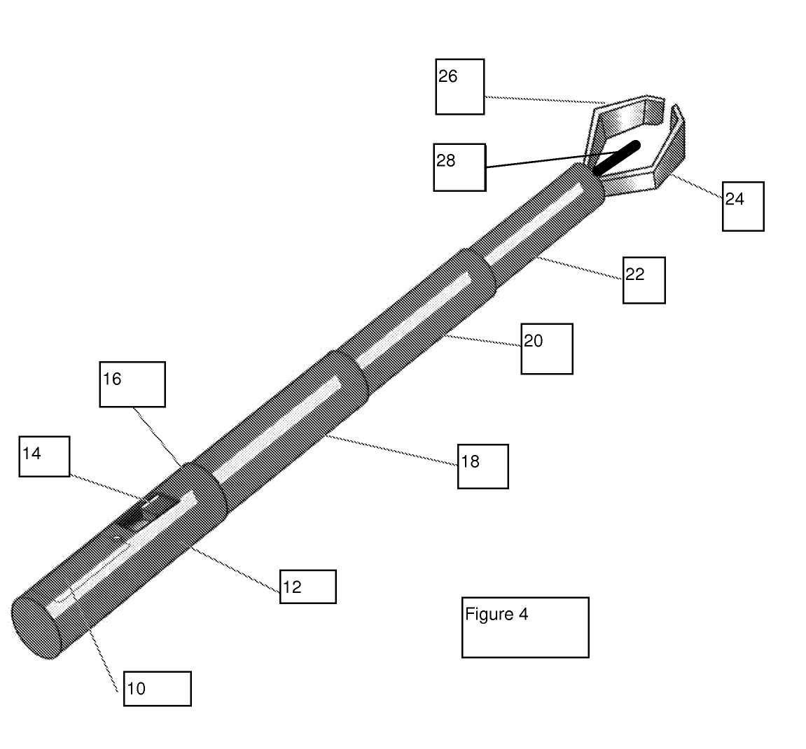

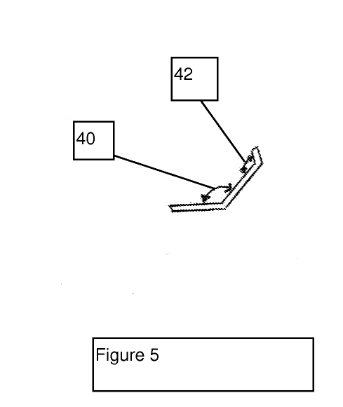

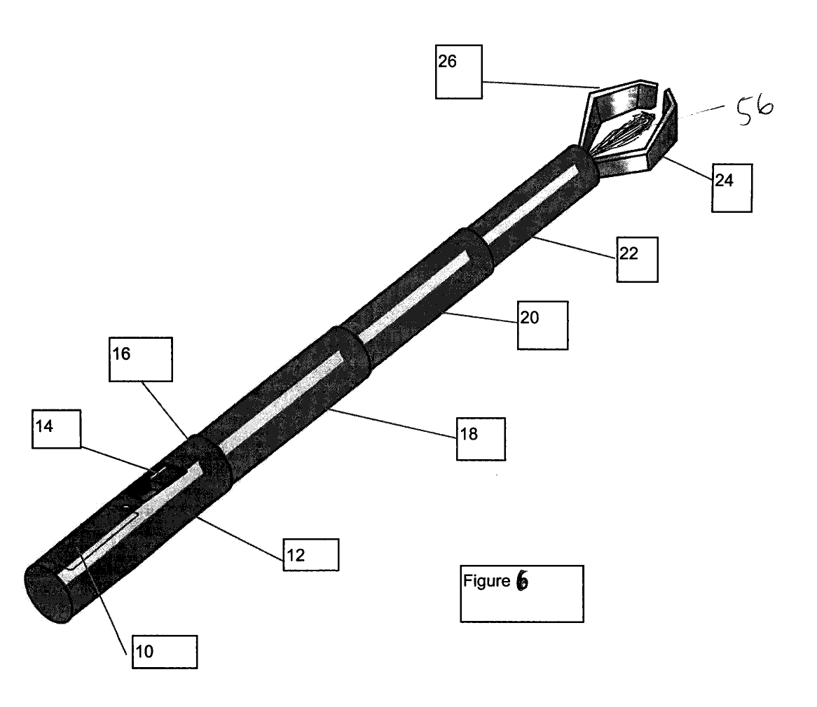

With reference to FIGS. 1-5, an apparatus (16) for grasping items located at a distance from the operator, the apparatus (16) comprising: a hook (made up of opposing sides 26 and 24); a power means (10); an actuation means (14); a telescoping barrel (made up of rings 18, 20, 22) in communication with the hook (made up of opposing sides 26 and 24); a handle (12) in communication with the telescoping barrel (made up of rings 18, 20, 22); an extending means contained within the telescoping barrel (made up of rings 18, 20, 22) and in electrical communication with the actuation means (14) and power means (10), wherein the extending means extends the telescoping barrel and the actuation means (14) actuates the hook (made up of opposing sides 26 and 24) according to user input (such as pressing actuation means (14) which is a button as shown) and the extending means. This is optional. The hook may be in a static position, which may be desirable for the purpose of obtaining clothing on a hanger at an elevated portion. Alternatively, the hook may be a grasping hook which would open and shut. The telescoping barrel, as shown, is at least three rings, wherein a first ring (18) is the largest diameter, a second ring (20) is slightly smaller than the first ring (18) and a third ring (22) is smaller than the second ring (20) and the third ring (22) fits inside the second ring (20), the second ring (20) fits inside the first ring (18). The extending means would run inside of the rings and cause the rings and the grasping means to extend. The extending means may be any extending means known within the art. By way of example, this may be hydraulic or simply push each successive ring into a reversibly locking position. The hook is made of two opposing sides (26 and 24), each of the two opposing sides being a first portion at an angle between 95 and 175 degrees from a second portion and a third portion at an angle of 95 to 140 degrees to said second portion. A center support peg (28) interposed between first portion and the second portion in the center of the last portion of the telescoping barrel, in the case depicted the end of the third ring (22). There may also be at least one additional side (56), wherein the at least one additional side (56) is between the two opposing sides (26 and 24) to provide additional support. According to a preferred embodiment, the handle (12) contains the actuation means (14) and the power means (10). The actuation means (14) is selected from the group consisting of push button and rotation. The actuation means may actuate the actuation means and extend the telescoping barrel. For example, the user may press the button (14) and the telescoping barrels (18, 20 and 22) would extend. Alternatively, the handle (12) may be rotated, or a portion rotated to either extend the telescoping barrels or open and close a grasping hook, or both. According to a preferred embodiment, the telescoping barrel extends to a maximum length between ten and twenty inches.

It should be understood that the foregoing relates to preferred embodiments of the invention and that modifications may be made without departing from the spirit and scope of the invention as set forth in the following claims.

I claim:

1. An apparatus for grasping items located at a distance from the operator, said apparatus comprising:
a hook, wherein said hook has two opposing sides,
a center support peg interposed between said two opposing sides of said hook and in the center of the end portion of said telescoping barrel;
a power means;
an actuation means;
a telescoping barrel in communication with said hook;
a handle in communication with said telescoping barrel;
an extending means contained within said telescoping barrel and in electrical communication with said actuation means and said power means, wherein said extending means extends said telescoping barrel.

2. An apparatus as in claim 1, wherein said telescoping barrel is at least three rings, wherein a first ring is the largest diameter, a second ring is slightly smaller than said first ring and a third ring is smaller than said second ring and said third ring fits inside said second ring, said second ring fits inside said first ring.

3. An apparatus as in claim 1, wherein said hook is made of two opposing sides, each of said two opposing sides being a first portion at an angle between 95 and 175 degrees from a second portion and a third portion at an angle of 95 to 140 degrees to said second portion.

4. Art apparatus as in claim 3, further comprising a center support peg interposed between said first portion and said second portion in the center of the end portion of said telescoping barrel.

5. An apparatus as in claim 3, further comprising at least one additional side, wherein said at least one additional side is between said two opposing sides to provide additional support.

6. (canceled)

8. An apparatus as in claim 1, wherein said actuation means is selected from the group consisting of push button and rotation.

9. An apparatus as in claim 1, wherein said hook is a grasping hook and said actuation means actuates said grasping hook according to user input.

10. An apparatus as in claim 1, wherein said telescoping barrel extends to a maximum length between ten and twenty inches.

11. An apparatus as in claim 1, wherein said actuation means and said power means are contained within said handle.

12. An apparatus for grasping items located as a distance from the operator, said apparatus comprising:
a hook comprising two opposing sides, each of said two opposing sides being a first portion at an angle between 95 and 175 degrees from a second portion and a third portion at an angle of 95 to 140 degrees to said second portion;
a center support peg interposed between said first portion and said second portion in the center of the end portion of said telescoping barrel;
a power means;
an actuation means:
a telescoping barrel in communication with said hook, wherein said telescoping barrel is at least three rings, wherein a first ring is the largest diameter, a second ring is slightly smaller than said first ring and a third ring is smaller than said second ring and said third ring fits inside said second ring, said second ring fits inside said first ring;
a handle in communication with said telescoping barrel;
an extending means contained within said telescoping barrel and in electrical communication with said actuation means and said power means, wherein said extending means extends said telescoping barrel.

13. An apparatus as in claim 12, further comprising at least one additional side, wherein said at least one additional side is between said two opposing sides to provide additional support.

14. (canceled)

15. An apparatus as in claim 12, wherein said actuation means actuates said grasping hook according to user input.

16. An apparatus as in claim 12, wherein said telescoping barrel extends to a maximum length between ten and twenty inches.

17. An apparatus as in claim 12, wherein said hook is a grasping hook.

18. An apparatus as in claim 12, wherein said actuation means and said power means are contained within said handle.
